(19) United States
(12) Patent Application Publication
(10) Pub. No.: US 2020/0124088 A1
(43) Pub. Date: Apr. 23, 2020

(54) BEARING BUSH

(71) Applicants: VIBRACOUSTIC GMBH, Darmstadt (DE); Benteler Automobiltechnik GmbH, Paderborn (DE)

(72) Inventors: Bartolomeo Firszt, Gödenstorf (DE); Oliver Helmcke, Apensen (DE); Ulrich Fuhrmans, Hamburg (DE); Michael Mess, Seevetal (DE); Rodscha Drabon, Salzkotten (DE); Peter Koczar, Paderborn (DE); Dirk Rochell, Paderborn (DE); Lars Sievers, Willebadessen (DE)

(21) Appl. No.: 16/617,838

(22) PCT Filed: May 18, 2018
(86) PCT No.: PCT/EP2018/063156

§ 371 Date: Nov. 27, 2019

(30) Foreign Application Priority Data
May 29, 2017 (DE) 10 2017 111 668.0

(51) Int. Cl. F16C 17/10; F16C 33/10

(52) U.S. Cl. CPC F16C 17/10; F16C 33/102

(57) ABSTRACT

A bearing bush includes a core, an intermediate sleeve surrounding the core in a manner extending in a circumferential direction, an outer sleeve surrounding the intermediate sleeve in a manner extending in the circumferential direction, an elastomer body disposed between the intermediate sleeve and the outer sleeve, and a stop device. In embodiments, at axial ends of the core, the stop device protrudes from the core in a radial direction and limits a movement of the intermediate sleeve in an axial direction. The intermediate sleeve is mounted on the core and, relative to the stop device, in a circumferentially rotatable manner. The outer sleeve has several projections. The intermediate sleeve has at least one counter-projection which overlaps in the radial direction with the projections for limiting the axial deflection of the outer sleeve relative to the core.

This application is a National Stage Patent Application of International Patent Application PCT/EP2018/063156, filed May 18, 2018, which claims the benefit of German Application Serial No. 10 2017 111 668.0, filed May 29, 2017, the contents of each are incorporated by reference in their entireties.

### TECHNICAL FIELD

The invention relates to a bearing bush comprising a core, an intermediate sleeve surrounding the core in a manner extending in a circumferential direction, an outer sleeve surrounding the intermediate sleeve in a manner extending in a circumferential direction, and an elastomer body disposed between the intermediate sleeve and the outer sleeve. The stop device, at axial ends of the core, protrudes from the core in a radial direction and limits a movement of the intermediate sleeve in an axial direction. The intermediate sleeve is mounted on the core and, relative to the stop device, in a circumferentially rotatable manner.

### BACKGROUND

Bearing bushes are used for chassis components and may be configured as plain bearing bushes in which the outer sleeve is capable of rotating relative to the core. In order to prevent the outer sleeve from axially detaching from the core, a stop member may be provided at the axial end of the core, so that the axial mobility of the stop member relative to the core is limited. Plain bearings are known, for instance, from DE 10 2004 031 302 B4 and DE 10 2004 024 269 A1. Furthermore, bearing bushes are also known from DE 10 2009 053 592 A1 and JP HO 798 034 A.

### SUMMARY

It is the object of the invention to provide a bearing bush whose longevity is improved over the bearing bushes from the prior art.

The object is accomplished by the subject matter of claim 1. The dependent claims describe preferred embodiments of the subject matter of claim 1.

A bearing bush comprises a core, an intermediate sleeve, an outer sleeve, an elastomer body and a stop device. The intermediate sleeve surrounds the core in a manner extending in a circumferential direction. The outer sleeve surrounds the intermediate sleeve in a manner extending in a circumferential direction. The elastomer body is disposed between the intermediate sleeve and the outer sleeve. The stop device, at axial ends of the core, protrudes from the core in a radial direction and limits a movement of the intermediate sleeve in an axial direction. The intermediate sleeve is mounted on the core and, relative to the stop device, in a circumferentially rotatable manner. The outer sleeve has several projections. The intermediate sleeve has at least one counter-projection which overlaps in the radial direction with the projections for limiting the axial deflection of the outer sleeve relative to the core. The elastomer body has a protruding region, which protrudes beyond the intermediate sleeve in the axial direction and abuts against the stop device in a sealing manner.

In particular, the bearing bush is a rubber bearing with high axial rigidity which, because of high torsional loads, can be configured as a torsional plain bearing. The axial forces arising are preferably diverted via the intermediate sleeve. Since the intermediate sleeve is slidably disposed on the core (sliding function), a different flow of force is used in this case: here, as an axial plain bearing. No dirt should enter such a plain bearing, particularly not if the plain bearing is lubricated. For this purpose, the protruding region is disposed on the bearing bush.

The advantage of the invention is that, by providing the protruding region, the mounting of the intermediate sleeve on the core and the stop device is sealed in a particularly simple manner by the protruding region. In particular, compared to the prior art, it is not necessary to provide a separate seal by means of which the mounting of the intermediate sleeve on the core and the stop device is sealed.

According to the invention, the elastomer body is extended by the protruding region, so that the protruding region can be manufactured together with the elastomer body as a unit of the same material. It is thus not necessary to manufacture the seal in a separate process step and to attach the seal to the bearing bush in another separate process step. Rather, in the case of the bearing bush described herein, it is possible to realize the manufacture and attachment of the seal in a single process step, wherein this only one process step does not constitute an additional process step because the elastomer body, and thus also the protruding region, is provided in any case.

Due to the protruding region being formed together with the elastomer body as a unit of the same material, a leak, which is possible in conventional seals, is avoided, because there can be no leak between the protruding region and the elastomer body, where a leaky portion could develop in conventional seals, due to the configuration of the protruding region and the elastomer body as a unit of the same material.

In summary, it is to be noted that by providing the protruding region, the manufacture of a seal, on the one hand, can be simplified considerably because there is no necessity for manufacturing any additional seal, and that an improved sealing effect can be attained.

The bearing bush can preferably be used as a leaf spring eye bearing, e.g. in lightweight pickups, or as a link bearing in multi-link axles and twist beam axles. With the bearing bush, it is possible, in particular, to enable large torsion angles by means of the integrated possibility of a rotation in the circumferential direction of the outer sleeve relative to the core. At the same time, good isolation properties can be provided, as they are familiar from known rubber bearings.

By providing the projections and the counter-projection, high axial rigidity of the bearing bush can be attained in combination with the rotatable mounting of the outer sleeve on the core.

The core and the outer sleeve preferably form those parts of the bearing bush by means of which the bearing bush is attached to the vehicle. In particular, the core has a bore extending in the axial direction, by means of which the core, and thus the bearing bush, can be secured on a bolt, for example. The outer sleeve may be accommodated, for example, in the bearing eye. The core may have a single-part or two-part configuration, wherein a two-part core is divided with respect to the axial direction, compared with a single-part core.

The intermediate sleeve surrounds to core in a manner extending in a circumferential direction, wherein it must be stated that the intermediate sleeve need not surround the core in a manner completely extending in a circumferential direction, so that the intermediate sleeve has a slit extending in the radial direction, for example. Moreover, the intermediate sleeve may be composed of several parts that each extend in the circumferential direction and are spaced apart in the circumferential direction. For example, the individual parts of the intermediate sleeve are uniformly distributed along the circumferential direction.

The circumferential direction, together with the axial direction and the radial direction, forms a cylindrical coordinate system, wherein the basis vectors of the circumferential direction, the radial direction and the axial direction are orthogonal to each other. In particular, the axial direction corresponds to an axis of rotation of the bearing bush.

The outer sleeve also surrounds the intermediate sleeve in a manner extending in the circumferential direction. It also applies in this case that the outer sleeve need not surround the intermediate sleeve in a manner completely extending in a circumferential direction, but may have one or several slits extending in the axial direction. Moreover, it is possible to form the outer sleeve from several parts, wherein each part is formed in a manner extending in the circumferential direction. The outer sleeve surrounds the intermediate sleeve and the core.

The intermediate sleeve may be made from plastic. The core, the stop device and/or the outer sleeve may be made from plastic, metal or an alloy.

The elastomer body is disposed between the intermediate sleeve and the outer sleeve and serves for isolating vibrations introduced in the radial direction and to provide the elastic properties of the bearing. The elastomer body may be configured as is known from the prior art. Optionally, the elastomer body is connected to the intermediate body by substance-to-substance connection, in particular attached by vulcanization to the intermediate body. Additionally or alternatively, it is possible for the elastomer body to also be connected to the outer sleeve positively and/or by substance-to-substance connection.

The stop device is provided at axial ends of the core and protrudes from the core in the radial direction. For example, the stop device may be formed by one or several flanges connected, at the axial end, to the core by substance-to-substance connection, nonpositively or positively. For example, when manufacturing the bearing bush, an annular disk, which limits a movement of the intermediate sleeve in the axial direction on both sides, may be pressed onto the core. In this case, the stop device is formed by two annular disks. Optionally, the annular disks are made from a material that differs from the material of the core, the outer sleeve and/or the intermediate sleeve. For example, the annular disks are made from plastic, whereas the other components of the bearing bush are made from metal.

Because of the combination of a rotational plain bearing and axial rigidity, the stop device is necessary, particularly in the form of lateral annular disks, which have to be sealed accordingly because a sliding function is also integrated here.

Moreover, it is optionally possible that the stop device is formed by one or several stops protruding from the core in the radial direction, wherein the stop or stops are formed together with the core as a unit of the same material. For example, the stops can be configured in the form of the annular disk or as elements protruding axially in the circumferential direction.

It is also possible to provide, on the one axial side of the bearing bush, an annular disk that can be pressed onto the core, and a stop on the other side, which is formed as a unit of the same material together with the bearing core. In the case where the stops on the two axial sides of the bearing bush are formed as a unit of the same material together with the core, the core has, in particular, a two-part configuration, so that the two parts of the core can be pushed into the intermediate sleeve in the axial direction.

In order to provide the plain bearing properties of the bearing bush, the intermediate sleeve is rotatably mounted relative to the core and the stop device. For this purpose, for example, a first gap may be provided between the intermediate sleeve and/or the stop device on the one hand, and between the intermediate sleeve and the core on the other hand, which is optionally filled with a lubricant. However, it is also possible that a member enabling the rotatable mounting of the intermediate sleeve on the core is provided between the intermediate sleeve on the one hand and the core and/or the stop device on the other hand. For example, this may be realized by means of a thin elastomer layer.

The projections preferably project radially inward from the outer sleeve. In particular, the projections are arranged substantially perpendicularly to the axial direction of the bearing bush. In cross section, i.e. viewed in the circumferential direction, the projections may be configured to be rectangular with angular and/or round edges. In particular, two projections may form a groove into which the counter-projection reaches. The elastomer body preferably extends along the projections.

The counter-projections of the intermediate sleeve preferably extend outwards in the radial direction, i.e. towards the outer sleeve. The counter-projection may be arranged substantially perpendicularly to the axial direction also in this case. The counter-projection may also optionally be configured to be rectangular in cross section, i.e. viewed along the circumferential direction, with rounded or angular edges. The elastomer body extends, also optionally, along the counter-projections.

It is optionally provided that the projections and or the counter-projection extend substantially perpendicularly to the axial direction of the bearing bush. In particular, axial side surfaces of the projections and/or of the counter-projection in this case extend substantially perpendicularly to the axial direction, i.e. substantially parallel to the radial direction. Substantially means that a deviation of up to ±25°, particularly up to ±15°, is possible. The extent of the axial side surface of the projection and of the counter-projection perpendicular to the axial direction offers a particularly high axial rigidity. In particular, the axial side surface of the projection is disposed so as to extend parallel to the axial side surface of the adjacent counter-projection. The region of the elastomer body, which contributes to axial rigidity and is compressed in a preferred embodiment, is disposed between these axial side surfaces.

Optionally, three or more projections and/or two or more counter-projections may be provided. In particular, several projections and counter-projections are provided, so that the outer sleeve is intermeshed with the intermediate sleeve. This intermeshing increases the axial rigidity of the bearing bush. Preferably, the elastomer body extends between the projection and the counter-projection in such a way that the elastomer body also acts in an axial direction. It may be provided that the elastomer body, at flanks of the projections, i.e. at axial side surfaces of the projections where the elastomer body acts in the axial direction, is configured to be thinner than in regions at the bottom of the groove formed of two counter-projections, where the elastomer body acts in the radial direction. It may also be provided that the elastomer body has a constant thickness.

The protruding region is preferably formed as a unit of the same material together with the elastomer body. This means that the elastomer body and the protruding region can be manufactured in a single process step, e.g. in the same vulcanization process step. The protruding region acts as a seal for sealing the first gap, for example. The protruding region abuts in a sealing manner against the stop device in such a way that the intermediate sleeve is able to move relative to the stop device and the core. Preferably, the protruding region seals the first gap between the intermediate sleeve and the stop device by the protruding region abutting against the stop device and also abutting against the intermediate sleeve due to the connection to the elastomer body. Alternatively, the elastomer body is attached by vulcanization to the outer sleeve. The protruding region may be provided on one or both axial ends of the bearing bush. Preferably, the protruding region extends completely in the circumferential direction.

It is preferred that the protruding region abuts against a circumferential face of the stop device.

The circumferential face of the stop device is the face of the stop device facing towards the observer if the latter looks along the radial direction. Thus, the circumferential face extends in the circumferential direction. Optionally, the circumferential face has a circular course, viewed in the axial direction. In particular, the circumferential face is the face of the stop device that has a smaller surface area compared with the axial side surfaces of the stop device. In this way, the surface area between the protruding region and the stop device can be reduced, which results, in particular, in low friction between the protruding region and the stop device when the core is rotated relative to the outer sleeve.

It is preferred that the intermediate sleeve, on axial ends, has one limiting projection, respectively, which projects in the radial direction from the intermediate sleeve.

The limiting projection can be considered a special embodiment of the counter-projection. The stop surface between the intermediate sleeve and the stop device is increased in the axial direction by means of the limiting projection, in order to provide for a better transmission of forces for limiting the intermediate sleeve in the axial direction. In particular, the limiting projection is configured to be parallel to the stop device on the side facing towards the stop device. For example, the limiting projection and the stop device, on the sides facing each other, extend parallel to the radial direction.

Further, the protruding region abutting against the circumferential face of the stop device is advantageous in that, in the event of an axial deflection of the outer sleeve, and thus also of the intermediate sleeve, relative to the core, the protruding region is not subjected to compression, whereby the lifespan of the protruding region, and thus the sealing effect, can be extended.

It is preferred that the protruding region is disposed between the stop device and the intermediate sleeve, in particular between the stop device and the limiting projection.

This embodiment may be used in addition or as an alternative to the previously described embodiment, in which the protruding region abuts against the circumferential face of the stop device. In this embodiment, for example, a part of or the entire protruding region extends in the first gap between the stop device and the intermediate sleeve, in particular the limiting projection.

It may be provided that the protruding region is disposed only at one axial end or at both axial ends between the stop device and the intermediate sleeve. Although, by disposing the protruding region between the stop device and the intermediate sleeve, the surface is reduced to which friction is applied when the outer sleeve is rotated relative to the core, and the contact pressure is increased, an effective alternative or additional sealing system can be produced in this way.

It is preferred that the intermediate sleeve, at an axial face facing towards the stop device, and/or the stop device, at an axial face facing towards the intermediate sleeve, have a cutout in which the projecting region is optionally disposed.

The cutout may be provided both on the intermediate sleeve and on the stop device, or on one of the two parts. In particular, the cutout is disposed on the intermediate sleeve.

In order to increase the strength of the protruding region and thus obtain a permanent sealing effect, it is advantageous if the protruding region is configured with a certain thickness. However, the first gap provided between the intermediate sleeve and the stop device may have a thickness that is less than the thickness required for the protruding region. Therefore, the cutout in which the protruding region is disposed may be provided on the intermediate sleeve and/or the stop device. In particular, the length and depth of the cutout are adapted to the dimensions of the protruding region.

It is preferred that the projecting region has at least one sealing lip abutting against the stop device.

One or several first sealing lips may be provided. The first sealing lip may abut against the circumferential face of the stop device of against the axial face of the intermediate sleeve and/or of the stop device. In particular, the sealing lip serves for reducing the abutting surface of the protruding region to the stop device, which improves both the sealing properties and the longevity, particularly in the event of torsion between the outer sleeve and the core. The sealing lip is preferably configured as a unit of the same material together with the protruding region, but may also be configured as a member that, though connected to the protruding region, is nevertheless separate.

It is preferred that a surface between the intermediate sleeve and the core and/or between the intermediate sleeve and the stop device is provided with a lubricant for optimizing the sliding friction characteristics.

During assembly, a first gap is preferably provided between the intermediate sleeve and the core, wherein the first gap is preferably filled with the lubricant. However, when the bearing bush is mounted, e.g. into the receiving eye, this first gap is closed to the extent that a clearance-free plain bearing is produced between the core and the intermediate sleeve.

Providing the first gap serves for producing the rotatable mounting of the intermediate sleeve on the core and/or for mounting the intermediate sleeve rotatably relative to the stop device. Thus, the intermediate sleeve is able to slide on the core and/or the stop device. The lubricant is provided in order to improve the sliding friction characteristics and to reduce wear on the intermediate sleeve, the core and/or the stop device. For example, greases or oils may be used as lubricants. Providing the protruding region, on the one hand, prevents the entry of dirt into the first gap and, on the other hand, suppresses a leakage of the lubricant from the first gap. Therefore, the longevity of the bearing bush is improved by providing the protruding region.

It is preferred that the core and/or the intermediate sleeve have at least one recess for accommodating the lubricant, in particular in the form of a lubricant groove extending in the axial direction.

In particular, the recess for accommodating the lubricant serves as a reservoir for the lubricant. By providing the recess, the volume for accommodating the lubricant can be increased, so that more lubricant is provided for mounting the intermediate sleeve on the core in a sliding manner. Moreover, the recess may be provided as a pocket, i.e. a space delimited both in the circumferential direction and the axial direction, in the intermediate sleeve and/or the core. It is preferred, however, that the recess is configured as a lubricant groove extending along the axial direction, particularly along the entire length of the intermediate sleeve in the axial direction.

It is preferred that the recess is disposed at an axial outer face of the intermediate sleeve facing towards the stop device.

In addition to the lubricant groove, a pocket for accommodating lubricant may also be provided at the axial outer face of the intermediate sleeve, in particular of the limiting projection. Extending the lubricant groove to the axial outer face of the intermediate sleeve, in particular of the limiting projection, and/or providing a separate lubricant groove in the radial direction on the axial outer face, and/or providing a pocket at the axial outer face serves for improving the mounting of the intermediate sleeve on the stop device in a sliding manner, by a lubricant reservoir being provided also on the axial outer face in order to improve the mounting in a sliding manner between the intermediate sleeve and the stop device. Thus, the lubricant groove extends in the radial direction.

It is preferred that the elastomer body is attached by vulcanization to the outer sleeve.

In this case, the protruding region may also abut against an axial outer face of the outer sleeve. An axial outer face of the outer sleeve is the face that, if no protruding region is provided, is visible if an observer looks at the bearing bush along the axial direction. The protruding region abutting against the axial outer face prevents dirt from being able to enter between the elastomer body and the outer sleeve. In particular, the protruding region is firmly applied to the axial outer face of the outer sleeve when the elastomer body is firmly connected to the outer sleeve. For example, the protruding region may be attached by vulcanization to the axial outer face. Alternatively, the protruding region may abut against the axial outer face in a sliding manner.

It is preferred that the elastomer body is partially spaced apart from the outer sleeve and/or the intermediate sleeve by a second gap.

The second gap extends at least partially along the outer sleeve and/or the core device in the axial direction. Preferably, several second gaps are provided, which are provided so as to be spaced apart in the axial direction, for example. The second gap may also be considered a free space. In particular, the second gap is filled with a gas, e.g. air. Optionally, the second gap extends completely in the circumferential direction, wherein it is also possible that the second gap is interrupted in the circumferential direction, e.g. by the elastomer body.

Particularly when the elastomer body is connected to the intermediate sleeve, the second gap is provided between the elastomer body and the outer sleeve, whereas the second gap is preferably provided between the intermediate sleeve and the elastomer body if the elastomer body is connected to the outer sleeve. Providing the second gap affects the damping properties in the bearing bush in the case of vibrations acting in the radial direction. The elastomer body, at least in the region in which the second gap is provided, is not compressed in the case of small vibrations, so that in the event of vibrations in the radial direction, the elastomer body acts only in those regions in which no second gap is provided. In this way, only parts of the elastomer body, and not the entire elastomer body, are compressed in the case of vibrations smaller than the thickness of the second gap. In the case of vibrations that are smaller than the thickness of the second gap in the radial direction, this results in a lower rigidity in the radial direction than in the case of greater vibrations, in which the elastomer body is also compressed in the radial direction, adjacent to the second gap.

It is preferred that the elastomer body has a second sealing lip sealing the second gap.

Preferably, the outer sleeve has an axial first end portion and an axial second end portion, wherein the first end portion and/or the second end portion are spaced apart from the elastomer body by the second gap. This is realized, in particular, by the projections of the outer sleeve being spaced apart from the axial ends of the outer sleeve, so that the outer sleeve is not limited in the axial direction by the projections but has the first and second end portions.

The second gap, which is closed either by the protruding region abutting against the axial outer face of the outer sleeve and/or by providing the second sealing lip, is provided between the first and second end portions on the one hand, and the elastomer body on the other hand. In particular, the second sealing lip protrudes outwards in the radial direction and preferably extends entirely along the circumferential direction.

Preferably, providing the first axial end portion and the second axial end portion is useful if at least two of the projections overlap in the radial direction with the limiting projections for limiting the axial deflection of the outer sleeve relative to the core. In this way, the limiting projection is able to reach into the space defined by the first and/or second axial end portions and the projections. At the first and/or second axial end portions, the second gap interacts with the respective limiting projection.

It is preferred that the second gap is disposed between two projections and/or between two counter-projections.

It is thus possible that the second gap interacts with the respective counter-projection reaching between the two projections and/or with the projection reaching between the two counter-projections.

It is preferred that the elastomer body has an additional padding member extending into the second gap.

Optionally, the additional padding member has a convexly curved outer contour. The convexly curved outer contour extends into the second gap. In particular, the cross section can be seen along a plane extending in the axial direction. If the additional padding member is configured in this manner, the effective surface area of the elastomer body being compressed increases as the radial deflection of the outer sleeve relative to the intermediate sleeve increases. In this way, the rigidity of the bearing bush in the radial direction progressively increases.

The additional padding member may extend into the second gap completely along the circumferential direction, or be disposed, in portions, in the circumferential direction. Optionally, the additional padding member is assigned to every second gap. In an axial cross section, i.e. viewed in the circumferential direction, the additional padding member has a surface area that is smaller than the second gap if no additional padding member is provided. This means that, compared to providing a second gap, more volume of the elastomer body is effective in the radial direction and, compared to omitting the second gap, less volume of the elastomer body is effective in the radial direction.

The additional padding member preferably abuts against the outer sleeve or the intermediate sleeve. This embodiment results in a stiffness in the radial direction which is smaller than for the case where no second gap is provided, but which is greater than for the case where a second gap is provided. Thus, the rigidity curve of the bearing bush can be varied by means of the additional padding member.

Particularly in an alternative embodiment, the additional padding member does not contact the outer sleeve adjacent to the second gap and/or the intermediate sleeve adjacent to the second gap. In the case of vibrations with small amplitudes, the rigidity of the elastomer body is changed by providing the additional padding member as compared to a situation in which the additional padding member is not provided. In the case of variations whose amplitude is not greater than the thickness of the second gap in the radial direction, the additional padding member is at first not effective, resulting in a low rigidity.

If the additional padding member now contacts the intermediate sleeve and/or the outer sleeve, the volume of the elastomer body that is being compressed increases, so that the rigidity increases. In the case of vibrations whose amplitude is greater than the thickness of the second gap, the entire elastomer body is now effective, so that the rigidity increases further. Thus, three rigidities and a smooth transition between the different degrees of rigidity can be set by providing the additional padding member.

It is preferred that the intermediate sleeve and/or the elastomer body has a slit extending in the axial direction. Preferably, the slit extends completely through the intermediate sleeve and/or the elastomer body. By providing the slit, a clearance-free contact in the sliding pairing of the intermediate sleeve and the core can be set by means of a bias on the intermediate sleeve and/or the elastomer body.

Another aspect of the invention relates to a method for producing the above-described bearing bush, wherein the elastomer body and the protruding region are manufactured together in a first process step. As an optional second process step, the elastomer body is connected to the intermediate sleeve, in particular attached thereto by vulcanization. Alternatively, the elastomer body is connected to the outer sleeve, particularly attached thereto by vulcanization. In a third process step, the outer sleeve is then placed on the elastomer body. This procedure makes it possible to configure the outer contour of the elastomer body, i.e. the surface of the elastomer body facing towards the outer sleeve, particularly accurately. In particular, it is possible to provide the additional padding member with a particularly accurate outer contour. In this way, a bearing bush can be manufactured in which the second gap is disposed between the outer sleeve and the elastomer body and the additional padding member protrudes radially outwards from the elastomer body into the second gap.

### BRIEF DESCRIPTION OF THE DRAWINGS

The invention will be explained in more detail with reference to the attached drawings. In the drawings:

FIG. 1 shows a schematic representation of a first embodiment of a bearing bush;

FIG. 2 shows a sectional view along the line of cut A-A from FIG. 1;

FIG. 3 shows an enlarged section of a second embodiment of the bearing bush;

FIG. 4 shows an enlarged section of a third embodiment of the bearing bush;

FIG. 5 shows an enlarged section of a fourth embodiment of the bearing bush;

FIG. 6 shows a schematic representation of the way in which the bearing bush according to FIG. 1 is produced;

FIG. 7 shows a schematic representation of a fifth embodiment of a bearing bush;

FIG. 8 shows a schematic representation of a sixth embodiment of a bearing bush;

FIG. 9 shows a cross sectional view along the cut B-B from FIG. 8;

FIG. 10 shows a schematic representation of a seventh embodiment of a bearing bush in a sectional view according to the line of cut B-B; and

FIG. 11 shows a schematic representation of an eighth embodiment of the bearing bush.

### DETAILED DESCRIPTION

A bearing bush 10 has a core 11, an intermediate sleeve 12, an elastomer body 13, an outer sleeve 16, and a stop device 17. The core 11 serves for attaching the bearing bush 10 to a part of a vehicle. In particular, the core 11 has an axial bore through which a bolt for attaching the bearing bush 10 can be pushed.

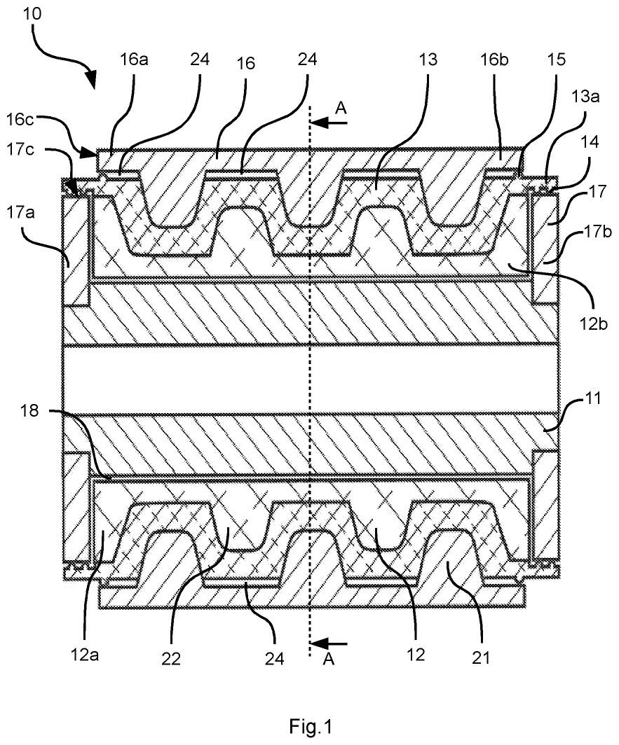

Optionally, the core 11 is a single-part component. The stop device 17 may be pressed onto the core 11. In the embodiment illustrated in FIG. 1, the stop device 17 is formed by a first annular disk 17a and a second annular disk 17b which are each pressed onto the core 11. The stop device 17 serves for limiting an axial deflection of the intermediate sleeve 12 relative to the core 11.

By means of a first gap 18, the intermediate sleeve 12 is mounted on the core 11 in a circumferentially rotatable manner. Moreover, the first gap 18 extends between the intermediate sleeve 12 and the stop device 17. However, when the bearing bush 10 is mounted, the first gap 18 is closed to the extent that a clearance-free plain bearing is produced between the core 11 and the intermediate sleeve 12. Furthermore, when the stop device 17 is provided, the first gap 18 is made smaller to such an extent that a clearance-free plain bearing is also produced between the stop device 17 and the intermediate sleeve 12. Thus, the intermediate sleeve 12 is rotatably mounted also relative to the stop device 17. Thus, the first gap 18 is represented in an enlarged manner in the Figures. The first gap 18 is filled with a lubricant, particularly a lubricating grease, in order to provide a low-wear sliding mounting of the intermediate sleeve 12 on the core 11 and the stop device 17, or to set the sliding friction characteristics in a targeted manner. Furthermore, the coefficient of static friction and the coefficient of sliding friction can be adjusted by providing the lubricant, which can contribute to preventing noise.

In the embodiment shown in FIG. 1, the intermediate sleeve 12 has four counter-projections 22 projecting in the radial direction towards the outer sleeve 16. Two of the counter-projections 22, which are provided at the axial ends of the intermediate sleeve 12, may be configured as a first limiting projection 12a and a second limiting projection 12b. An axial outer face of the first and second limiting projections 12a, 12b facing towards the stop device 17, particularly the first annular disk 17a and the second annular disk 17b, is configured to be parallel to the extent of the first annular disk 17a and the second annular disk 17b, respectively.

The outer sleeve 16 has projections 21 projecting in the radial direction from the outer sleeve 16 towards the intermediate sleeve 12. The outer sleeve 16 has a first axial end portion 16a and a second axial end portion 16b, which are disposed at the axial ends of the outer sleeve 16 and are respectively situated opposite the first limiting projection 12a and the second limiting projection 12b.

The elastomer body 13 is provided between the outer sleeve 16 and the intermediate sleeve 12. The elastomer body 13 is attached to the intermediate sleeve 12 by vulcanization. In the embodiment illustrated in FIG. 1, a second gap 24 is provided between the elastomer body 13 and the outer sleeve 16, particularly in the region of the first end portion 16a, the second end portion 16b and between the projections 21. The second gap 24 preferably extends in the entire circumferential direction. Optionally, the projections 21 and the counter-projections 22 may also extend in the entire circumferential direction.

The elastomer body 13 has a protruding region 13a configured as a unit of the same material with the elastomer body 13. The protruding region 13a protrudes in the axial direction beyond the intermediate sleeve 12 and, in particular, beyond the first limiting projection 12a and the second limiting projection 12b. The protruding region 13a is provided on both axial ends of the bearing bush 10.

In the embodiment illustrated in FIG. 1, the protruding region 13a abuts against a circumferential face 17c of the stop device 17. In particular, the protruding region 13a has first sealing lips 14 abutting against the circumferential face 17c of the stop device 17. The contact surface between the protruding region 13a and the stop device 17 is reduced by providing the first sealing lips 14, which minimizes the abutting surface in the case of a rotation of the outer sleeve 16, and thus of the intermediate sleeve 12, relative to the core 11 and thus the stop device 17, thus offering a good sealing effect with, at the same time, a longer service life. The first gap 18 is sealed by means of the protruding region 13a, so that the lubricant cannot escape from the first gap 18 and the entry of dirt into the first gap 18 is prevented.

Optionally, the protruding region 13a has a second sealing lip 15, which abuts against the outer sleeve 16, particularly against the first axial end portion 16a and the second axial end portion 16b. The second sealing lip 15 seals the second gap 24, so that dirt cannot enter the second gap 24. Optionally, the first sealing lip 14 and/or the second sealing lip 15 are formed as a unit of the same material with the protruding region 13a.

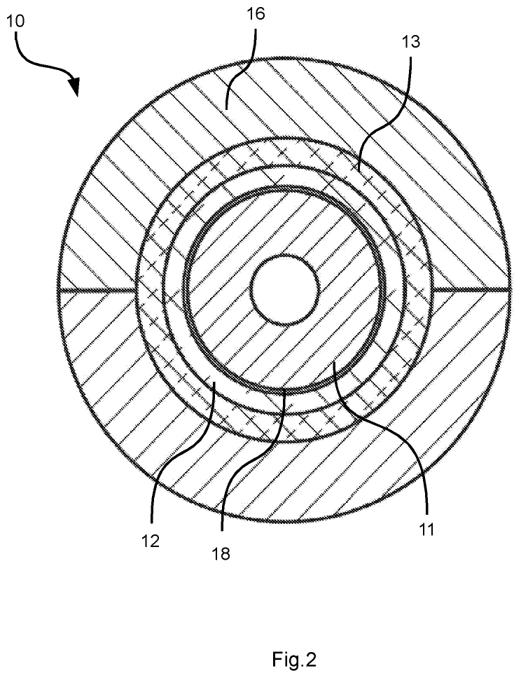

As is apparent particularly from FIG. 2, the outer sleeve 16 has a two-part configuration. In particular, the two parts of the outer sleeve 16 consist of two half-shells which, in the mounted state, contact each other at an edge extending in the axial direction.

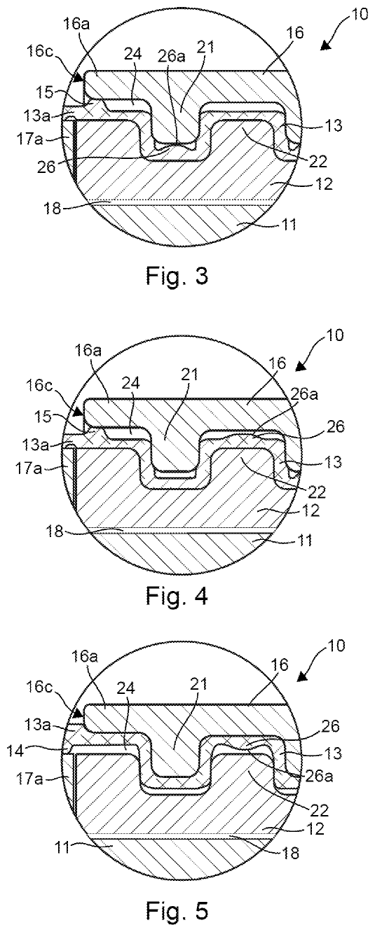

With the exception of the following differences, the embodiment of the bearing bush 10 shown in FIG. 3 matches the embodiment shown in FIG. 1. In this embodiment, the first gap 18 is not only provided between the two projections 21, but also between the two counter-projections 22. In this case, the second gap 24 is respectively disposed between the outer sleeve 16 and the elastomer body 13. Moreover, the elastomer body 13 has an additional padding member 26 with a convexly curved outer contour 26a. The additional padding member 26 extends into the second gap 24. In the embodiment illustrated in FIG. 3, the additional padding member 26 is respectively disposed between two counter-projections 22.

Furthermore, the thickness of the elastomer body 13 between the projection 21 and the counter-projection 22 is chosen in such a way that the elastomer body 13 is compressed between the projection 21 and the counter-projection 22. In the region in which the elastomer body 13 extends substantially in the radial direction, the elastomer body 13 is compressed between the projection 21 and the counter-projection 22. This means that in the case in which the outer sleeve 16 is not provided, the thickness of the elastomer body 13 is greater (see dashed line in FIG. 3) than in the case in which the outer sleeve 16 were provided. In the region of the extent in the axial direction, the thickness of the elastomer body 13 is greater than the distance between axial side surfaces of the projection 21 and the counter-projection 22.

Axial side surfaces of the projections 21 and/or of the counter-projections 22 extend almost perpendicularly to the axial direction, i.e. almost parallel to the radial direction. A deviation of up to ±25°, particularly up to ±15°, is possible, as is indicated in FIG. 1, for instance. Furthermore, the projection 21 and the counter-projection 22 overlap in the radial direction, so that an intermeshing between the projections 21 and the counter-projections 22 is accomplished.

The overlap in the radial direction between the projection 21 and the counter-projection 22 is as great as possible, so that as much of the elastomer body 13 as possible is effective between the projection 21 and the counter-projection 22 in the event of a deflection in the axial direction, whereby high axial rigidity can be obtained. Further, the axial rigidity of the bearing bush 10 may be increased by as many projections 21 and counter-projections 22 as possible being provided. The bias of the elastomer body 13 between the projection 21 and the counter-projection 22 in the axial direction also increases the axial rigidity.

The radial rigidity of the bearing bush 10 also increases with the increase of the axial rigidity. The second gaps 24 are provided in order to counteract this effect. In particular, the second gap 24 serves as a freewheel, so that it is predominantly the rigidity of the additional padding member 26 that is effective in the case of radial vibrations with an amplitude smaller than the thickness of the second gap 24 in the radial direction. For this purpose, the additional padding member 26 abuts against the projection 21 and thus against the outer sleeve 16. Only when the additional padding member 26 is fully compressed does the elastomer body 13 come into contact with the outer sleeve 16 in the region of the second gap 24, in which no additional padding member 26 is provided, so that this region of the elastomer body 13 is also effective. Thus, this procedure results in a progressive course of the characteristic curve of the rigidity. In particular, the increase in the radial rigidity accompanying the increase of the axial rigidity can be compensated by providing the second gap 24 with and without an additional padding member 26.

The embodiment of the bearing bush 10 shown in FIG. 4 matches the embodiment shown in FIG. 3. The fact that the additional padding member 26 is provided, not between two counter-projections 22, but between two projections 21, must be considered the sole difference.

The embodiment of the bearing bush 10 shown in FIG. 5 matches the embodiments shown in FIGS. 3 and 4, except for the fact that the elastomer body 13 is connected to the outer sleeve 16, and not to the intermediate sleeve 12. For example, the elastomer body 13 may be attached by vulcanization to the outer sleeve 16. Optionally, the protruding region 13a abuts against an axial outer face 16c of the outer sleeve 16; in particular, the protruding region 13a is attached to the axial outer face 16c of the outer sleeve 16 by vulcanization. Thus, the second gap 24 is provided between the elastomer body 13 and the intermediate sleeve 12, wherein the additional padding member 26 protrudes radially inwards into the second gap 24. The second sealing lip 15 also protrudes radially inwards from the elastomer body 13 and abuts against the intermediate sleeve 12.

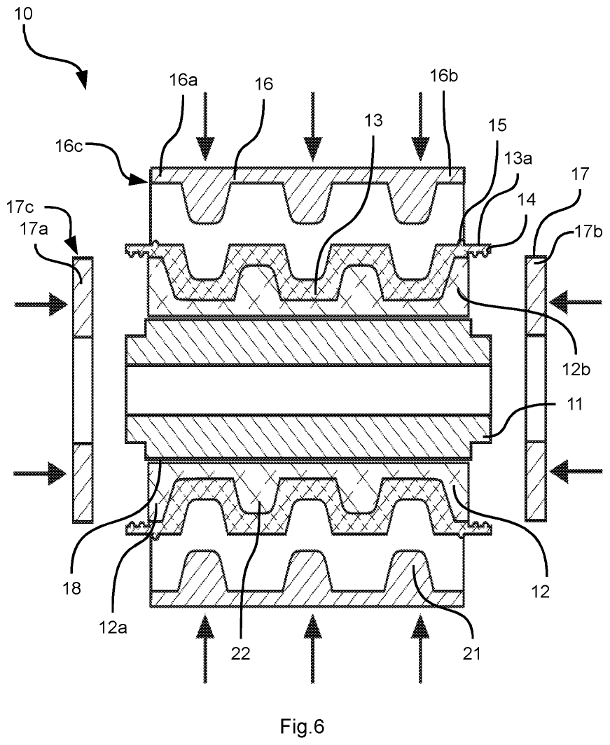

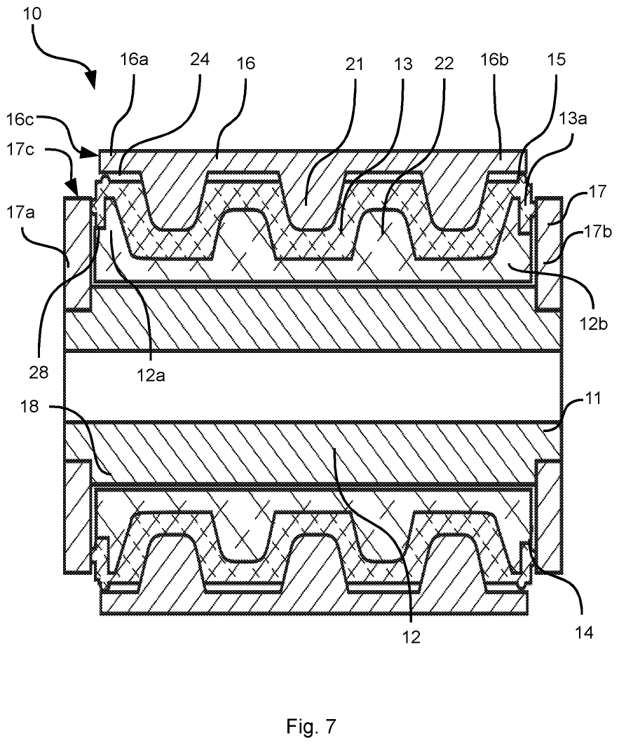

The assembly of the bearing bush 10 according to FIG. 1 is depicted in FIG. 6. First, the core 11 is provided and the intermediate sleeve 12 is pushed onto the latter. Prior to the intermediate sleeve 12 being pushed on, the elastomer body 13 with the protruding region 13a has optionally been attached to the intermediate sleeve 12 by vulcanization. After the intermediate sleeve 12 has been pushed onto the core 11, the stop device 17 is connected to the core 11, e.g. by pressing it on. Then, the two parts of the outer sleeve 16 are placed on the elastomer body 13.

In all embodiments shown, the elastomer body 13 may optionally be attached by vulcanization to both the intermediate sleeve 12 and the outer sleeve 16, wherein the protruding region 13a, in particular, is also attached to the axial outer face 16c of the outer sleeve 16 by vulcanization. Furthermore, it is possible that the elastomer body 13 is attached by vulcanization exclusively to the outer sleeve 16.

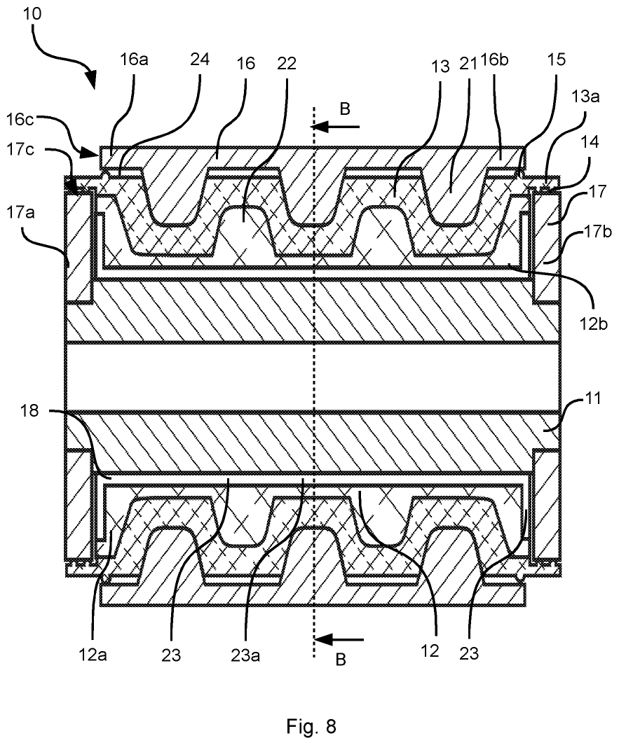

The bearing bush 10 according to FIG. 7 matches the bearing bush 10 according to FIG. 1 and only differs therefrom in that the protruding region 13a does not abut against a circumferential face 17c of the stop device 17. Rather, the protruding region 13a abuts against an axial face of the stop device 17 that faces towards the intermediate sleeve 12. Furthermore, a cutout 28, in which the protruding region 13a is disposed, is respectively provided on the intermediate sleeve 12, particularly on the first limiting projection 12a and the second limiting projection 12b. Thus, the protruding region 13a is disposed between the intermediate sleeve 12, in particular the first and second limiting projections 12a and 12b, and the stop device 17, in particular the first annular disk 17a and the second annular disk 17b. In this case, the sealing lip 14 protrudes from the intermediate sleeve 12 in the axial direction towards the stop device 17.

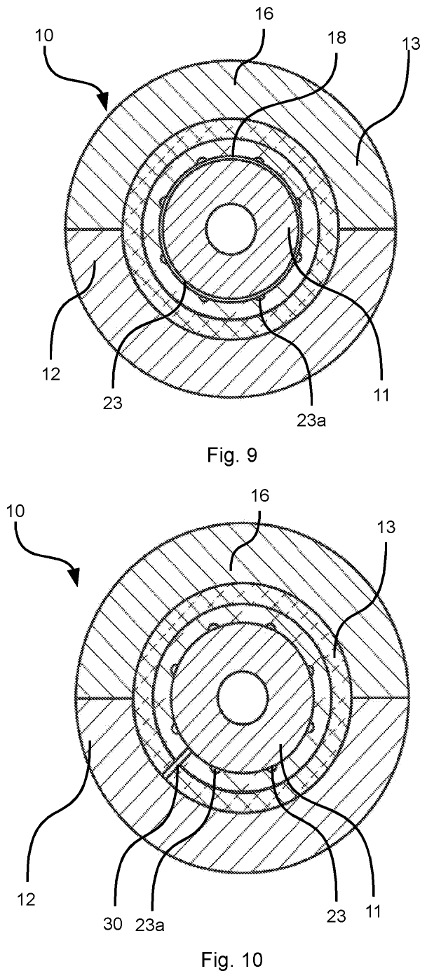

With the exception of the following differences, the bearing bush 10 according to FIG. 8 matches the bearing bushes 10 according to FIG. 1. The bearing bush 10 according to FIG. 8 additionally has a recess 23 in the form of a lubricant groove 23a. The recess 23 serves for accommodating a lubricant and thus acts as a lubricant reservoir. The recess 23 may also be configured as a pocket. In the embodiment illustrated in FIG. 8, the lubricant groove 23a is disposed in the intermediate sleeve 12 and extends over the entire axial length of the latter. Furthermore, the lubricant groove 23a extends in the radial direction along the first and second limiting projections 12a, 12b. In this case, the lubricant groove 23a is optionally provided in a circumferentially uniformly distributed manner, as is apparent from FIG. 9.

With the exception of the following differences, the bearing bush 10 according to FIG. 10 matches the bearing bushes 10 according to FIG. 1. In the bearing bush 10 according to FIG. 10, a slit 30, which extends in the axial direction and/or at a slight angle to the axial direction, is provided. The slit 30 extends in the radial direction through the intermediate sleeve 12 and the elastomer body 13. By means of the slit 30, a bias can be applied after placement of the outer sleeve 16, and the radial thickness of the first gap 18 can be adjusted.

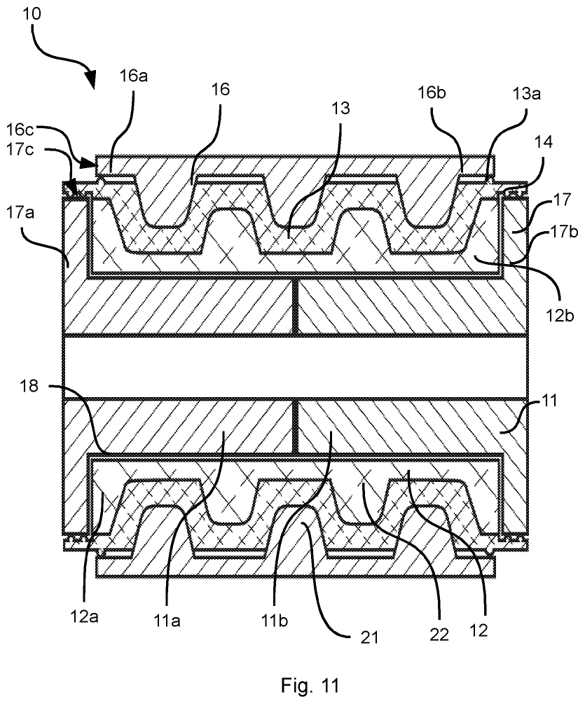

With the exception of the core 11 having a two-part configuration, the bearing bush 10 according to FIG. 11 matches the bearing bushes 10 according to FIGS. 1 to 10. A first core part 11a and a second core part 11b are separated from each other by a cut in the radial direction. In this embodiment, the stop device 17 is formed as a projecting member, which is integrally formed with the first core part 11a and the second core part 11b.

1. A bearing bush, comprising
a core,
an intermediate sleeve surrounding the core in a manner extending in a circumferential direction,
an outer sleeve surrounding the intermediate sleeve in the circumferential direction,
an elastomer body disposed between the intermediate sleeve and the outer sleeve, and
a stop device which, at axial ends of the core, protrudes from the core in a radial direction and limits a movement of the intermediate sleeve in an axial direction,
wherein the intermediate sleeve is mounted on the core and, relative to the stop device, in a circumferentially rotatable manner,
wherein the outer sleeve has several projections,
wherein the intermediate sleeve has at least one counter-projection which overlaps in the radial direction with the projections for limiting an axial deflection of the outer sleeve relative to the core, and
wherein the elastomer body has a protruding region, which protrudes beyond the intermediate sleeve in the axial direction and abuts against the stop device in a sealing manner.

2. The bearing bush according to claim 1, wherein the protruding region abuts against a circumferential face of the stop device.

3. The bearing bush according to claim 1, wherein the intermediate sleeve, on axial ends, has one limiting projection, respectively, which projects in the radial direction from the intermediate sleeve.

4. The bearing bush according to claim 1, wherein the protruding region is disposed between the stop device and the intermediate sleeve, between the stop device and the limiting projection.

5. The bearing bush according to claim 4, wherein the intermediate sleeve, at an axial face facing towards the stop device, and/or the stop device, at an axial face facing towards the intermediate sleeve, has a cutout in which the projecting region is disposed.

6. The bearing bush according to claim 1, wherein the projecting region has at least one sealing lip abutting against the stop device.

7. The bearing bush according to claim 1, wherein a surface between the intermediate sleeve and the core and/or between the intermediate sleeve and the stop device is provided with a lubricant.

8. The bearing bush according to claim 7, wherein the core and/or the intermediate sleeve have at least one recess for accommodating the lubricant, in a lubricant groove extending in the axial direction.

9. The bearing bush according to claim 8, wherein the recess is disposed at an axial outer face of the intermediate sleeve facing towards the stop device.

10. The bearing bush according to claim 1, wherein the elastomer body is attached by vulcanization to the outer sleeve.

11. The bearing bush according to claim 1, wherein the elastomer body is partially spaced apart from the outer sleeve and/or the intermediate sleeve by a second gap.

12. The bearing bush according to claim 11, wherein the elastomer body has a second sealing lip sealing the second gap.

13. The bearing bush according to claim 11, wherein the second gap is disposed between two projections and/or between two counter-projections.

14. The bearing bush according to claim 11, wherein the elastomer body has an additional padding member extending into the second gap.

15. The bearing bush according to claim 1, wherein the intermediate sleeve and/or the elastomer body has a slit extending in the axial direction.
